(19) United States
(12) Patent Application Publication
(10) Pub. No.: US 2002/0194621 A1
(43) Pub. Date: Dec. 19, 2002

(54) Multimedia interface control for consumer electronics device

(76) Inventors: Thanh T. Tran, Houston, TX (US); John J. Nagel, League City, TX (US); Jon Hayden, Friendswood, TX (US); Giang H. Dao, Houston, TX (US)

Correspondence Address: CONLEY ROSE & TAYON, P.C., P. O. BOX 3267, HOUSTON, TX, 77253-3267, US

(21) Appl. No.: 09/883,775

(22) Filed: Jun. 18, 2001

(51) Int. Cl. H04N 7/16

(52) U.S. Cl. 725/139; 725/100; 725/131

(57) ABSTRACT

A consumer electronics device includes a universal control logic unit to interface a plurality of input controls, a display and an antenna to a host system via a bus. The host system is located within a shielded enclosure, while the remaining components (e.g., input controls, display, antenna, universal control logic) are located outside the shielded enclosure. Because a single bus preferably is used to interface the various input/output components located outside the shielded enclosure to the shielded host system, the host system can be more easily and effectively shielded than if numerous separate electrical lines and busses were used to directly connect the various input/output devices to the host system.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to an interface control between one or more input/output (“I/O”) devices and a host system. More particularly, the invention relates to interface logic between I/O devices and a host system that provides a single communication link to the host system. More particularly still, the invention relates to a universal control circuit that provides a single communication link to a digital host system for a plurality of I/O devices and a display for showing information provided by the host system. The invention also relates to the synchronization of volume level visual indications on the display and a separate television monitor.

2. Background of the Invention

Consumers today have numerous types of devices at their disposal-personal computers, televisions, VCRs, DVDs, camcorders, cameras, cable set top boxes, satellite receivers, and the like. Information is available to consumers over a wide variety of media. Television programming, for example, is available over conventional wireless broadcasting, cable, and satellite. Static information is readily available in the form of data transmissions over the Internet, and Internet connections may be over standard telephone lines using modems, dedicated high speed land lines, satellite, and digital transmissions at higher frequencies on standard telephone cables, to name a few. Consumers thus have a wealth of information available to them in various formats and requiring different devices to receive, process and view the information.

In the face of the multimedia explosion, the “set top box” has been developed to simplify a user's access and control to the multimedia-based information. A set top box connects typically to a television monitor, an Internet medium (e.g., a DSL telephone line), and a television programming channel (e.g., a cable TV connection). A wireless keyboard can be provided to permit a user to operate the set top box. The set top box itself includes a host system typically comprising a central processing unit (“CPU”), memory, a fixed disk storage device, a floppy disk drive, and possibly a DVD player or other types of devices as desired. Using the wireless keyboard to control the set top box, a user can watch television programing or use the television and set top box together as a computer to perform conventional computer processing tasks, such as word processing, email, and the like. In short, the set top box and television effectively can perform the same functions as a television and separate computer system. The set top box can operate as a conventional computer system or as a consumer electronics device (e.g., DVD player). It is highly desirable in the consumer electronics market, including set top boxes, to make the equipment as “user friendly” and robust as possible. To make it easier on the user to operate the set top box, the keyboard, as noted above, may have a wireless link to the set top box. The wireless link may be a radio frequency (“RF”) or infrared (“IR”) link between the keyboard or handheld remote controller and the set top box. Other devices, such as a mouse, may also have an RF or IR link to the set top box. Having wireless links between the control devices the user operates and the set top box eliminates annoying cables draped across the room in which the user has the television and set top box (e.g., living room or bed room).

To further make operation of the set top box as user friendly as possible and in case of a battery failure or damaged remote control, one or more controls may be placed on the front panel of the box itself. Such controls may be used to operate the set top box's DVD player, and, accordingly, the buttons may be for functions such as “stop,” “play,” “pause,” “fast forward,” and the like. These types of buttons should be as easy to use as the comparable buttons on a conventional VCR.

The set top box also includes a host system board on which the CPU, memory and other digital electronic components are mounted. To protect the digital signals on the host system board from outside RF interference, the host system board preferably is contained within a metal housing. The metal surface of the housing acts as a shield against the intrusion and containment of electromagnetic interference. Although desirable to shield the digital electronics, the metal housing presents a problem for the wireless communication to the keyboard, remote control, or other peripherals. Both devices must have an antenna to provide the communication link. The RF antenna or IR receiver mounted in the set top box, however, cannot be located inside the metal housing, otherwise the metal housing will preclude RF signals from the keyboard from reaching the set top box antenna, and vice versa.

A solution to this problem is to locate the antenna outside the metal enclosure. One suitable solution would be to provide the metal set top box with an electromagnetically transparent front panel (i.e., one that is made from a material that does not interfere dramatically with the RF link). The set top box's RF antenna can then be mounted on the inside of the front panel. The front panel also provides a convenient location to mount the various buttons noted above (play, pause, etc.). All of the controls, however, must be electrically coupled in some way to the host system board located inside the metal enclosure. Routing numerous electrical lines from potentially numerous controls through openings in the metal enclosure tends to decrease the ability of the metal housing to adequately shield the electronics. Accordingly, a solution to this problem is needed.

Also, it would be desirable to provide a consumer electronics device, such as a set top box, with a display that includes controls (e.g., buttons, knobs) that can control the presentation of multimedia and provide a visual indication of changes in settings on a local display and/or television monitor. For example, if the consumer electronics device includes a volume knob for controlling the volume level of sound associated with a video, it would be desirable for the consumer device to provide an indication of the change in volume level locally and/or on the television monitor.

### BRIEF SUMMARY OF THE INVENTION

The problems noted above are solved in large part by a consumer electronics device that includes a universal control logic unit to interface a plurality of input controls, a display and an antenna to a host system via a bus. The host system is located within a shielded enclosure, while the remaining components (e.g., input controls, display, antenna, universal control logic) are located outside the shielded enclosure. Because a single bus preferably is used to interface the various input/output components located outside the shielded enclosure to the shielded host system, the host system can be more easily and effectively shielded than if numerous separate electrical lines and busses were used to directly connect the various input/output devices to the host system.

An embodiment of the invention is in the context of a “set top” box which couples to a television monitor, a pair of speakers and other multi-media devices. The set top box also includes a mass storage device, a DVD drive and other components as desired. The input controls and display preferably are located on the front panel of the set top box. The front panel preferably comprises a material through which wireless signals (e.g., radio frequency) can propagate. Behind the front panel is a metal enclosure which houses the host system. The universal control logic is located within the interstitial space between the metal enclosure and the front panel. In the context of a set top box, the input controls may be used for such functions as “play,” “stop,” “fast forward,” and the like. A volume knob also is provided on the front panel to control the level of sound to the speakers.

With the structure described herein, the universal control logic circuit can accommodate input and output devices having varying types of electrical interfaces. The universal control logic provides a single common interface to the host system. The host system preferably responds to user activation of the input controls and generates the information to be shown on the display.

The universal control logic preferably connects to the host system via a universal serial bus (“USB”) and preferably includes a USB hub, a USB interface circuit and a microcontroller. The input/output devices connect to general purpose input/output pins on the microcontroller. Status flag registers internal to the microcontroller are associated with each of the input and output devices. Whenever a user activates an input device (as detected by the microcontroller), the microcontroller sets the status flag associated with the activated input control. The microcontroller then alerts the host system over the single bus connection that a control has been activated and the host system determines which control was activated and performs the function associated with that particular control.

These and other advantages will become apparent upon reviewing the following description and drawings.

### BRIEF DESCRIPTION OF THE DRAWINGS

For a detailed description of the preferred embodiments of the invention, reference will now be made to the accompanying drawings in which:

FIG. 1 shows a block diagram of a set top box of the preferred embodiment;

FIG. 2 shows the front panel of the preferred set top box;

FIG. 3 shows a block diagram of an interface control circuit including a universal control logic unit;

FIG. 4 shows a block diagram of the universal control logic unit of FIG. 3;

FIGS. 5 and 6 show preferred methods illustrating the operation of the set top box and, in particular, the universal control logic;

FIGS. 7A and 7B illustrate the operation of the volume control on the set top box; and

FIG. 8 illustrates synchronizing dual volume level indicators on the set top box and a television monitor.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

The following description describes the preferred embodiment of the invention in the context of a set top box. However, it should be noted that the principles described herein are not limited to just set top box technology. In general, the apparatus and methods described herein can be applied to numerous types of consumer electronics and computer devices.

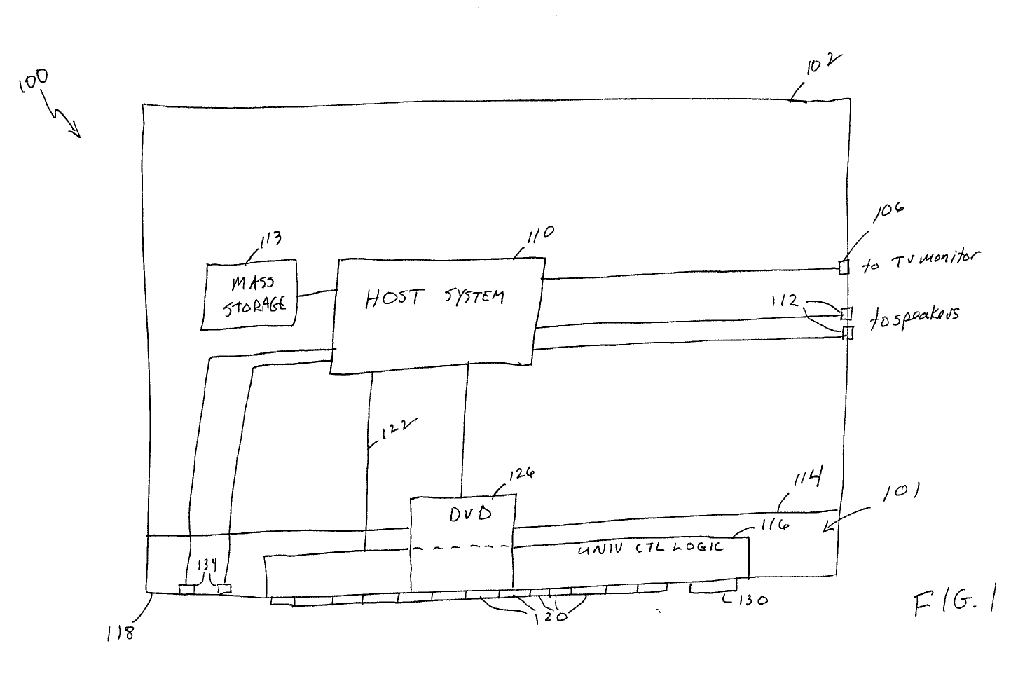

Referring now to FIG. 1, set top box 100 constructed in accordance with the preferred embodiment generally includes an enclosure 102, a front bezel member 118 and various electrical and mechanical components. As shown in the exemplary embodiment of FIG. 1, such components may include a host control system 110, a mass storage device 113, a universal control logic unit 116, a video device (e.g., DVD) 126, and various controls 120 and 130. Host system 110 preferably couples to the mass storage device 113, universal control logic unit 116, and DVD 126. One or more connectors 134 coupled to host system 110 may also be provided if desired. Host system 110 also provides a video and/or audio interface connection 106 to a television monitor (not shown). As such, interface 106 may comprise a video interface and right and left audio channels. The television interface may be the well-known NTSC standard or any other suitable television interface now known or later developed and used anywhere in the world. One or more audio speakers (not shown) can be coupled to the host system 110 via one or more audio connections 112.

Enclosure 102 in the preferred embodiment is manufactured from metal, such as bent sheet aluminum, to shield electronics contained therein, such as host system 110 and mass storage device 113 as shown. However, it should be understood that the enclosure 102 may also be constructed of other materials such as alloys, composites, or polymer-based materials, provided the internal electronics are adequately shielded. The bezel 118 preferably is constructed of plastic, or other material through which energy (e.g., RF energy) can propagate. Bezel 118 may also provide a “window” transparent to IR energy for communication with an IR control device. The front bezel 118 defines an interstitial space 101 between the bezel 118 and the front face 114 of enclosure 102. Various components such as universal control logic 116 discussed below are located within interstitial space 101. Those components are generally not shielded, but the components located within the enclosure 102 are shielded.

Referring still to FIG. 1, host system 110 preferably comprises a suitable type of control logic. One suitable implementation of host system 110 comprises a microprocessor and associated devices such as random access memory, bridge devices, modems, network interface devices, audio controllers, and the like. Other implementations, such as those including discrete devices and analog circuitry are also permissible.

Mass storage device 113 preferably comprises a suitably-sized hard disk drive. Other types of mass storage devices (e.g., CD ROM) can also be used as a mass storage device. Mass storage device could also comprise a floppy drive if desired, or alternatively, set top box 100 may include a floppy drive in addition to a hard drive 113. Host system 110 preferably communicates with mass storage device 113 to retrieve information from the storage device and store information on the storage device.

A DVD drive 126 is preferably also included to permit a user to watch video on a monitor (not shown) coupled to set top box 100 via interface connector 106. For ease of use, DVD drive 126 is located at or adjacent the front bezel 118. Connectors 134 are used to provide connectivity for IEEE 1394 and USB interfaces, or other types of interfaces.

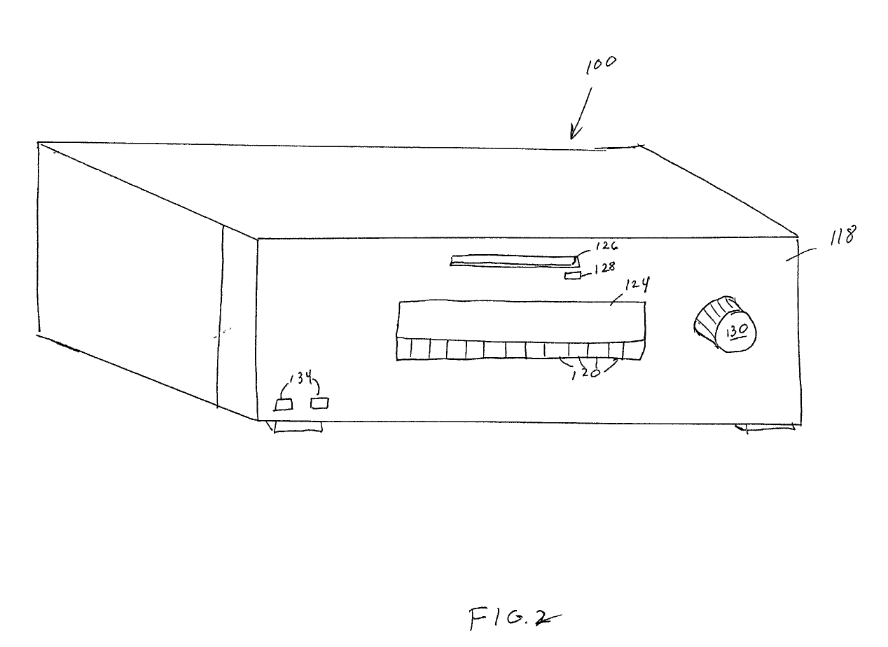

Referring now to FIG. 2, the front bezel 118 of set top box 100 is shown. As shown, various input/output devices are included to permit a user to control the operation of the set top box. As can be seen, DVD 126, input controls 120, a display 124, volume control 130, and connectors 134 preferably are provided. Input controls 120 preferably comprise push buttons, but can be implemented as any suitable type of input control. Volume control 130 preferably comprises a knob that can be turned one way to increase volume and the other way to decrease volume. Display 124 preferably comprises a liquid crystal display (“LCD”) or other suitable type of display device. Each of the input/output devices 120, 126, 124, and 130 preferably is electrically coupled to host system 110 located inside the metal enclosure 102.

The functions performed by the buttons 120 preferably are identified on the display 124. In accordance with the preferred embodiment of the invention, the display 124 is mounted adjacent buttons 120 to permit the host system 110 to display suitable information on the display 124 to inform the user as to the function performed by each button. As shown, the display is mounted immediately over the buttons, but many other configurations are possible as well. The 13 buttons 120 shown in FIG. 1 may be associated with the following 13 functions:

1. Play

2. Stop

3. Pause

4. Fast Forward

5. Reverse

6. Eject

7. DVD

8. Internet

9. TV

10. Games

11. CD

12. My Media (Files, JPEGs, etc)

13. AUX-auxiliary Host system 110 can cause the word “PLAY” or the well-known play-icon (rightward pointing arrow) to be displayed adjacent the button 120 identified to perform the play function. The functions performed by the other buttons 120 are similarly identified by descriptive words or symbols shown adjacent the buttons. Further, the function associated with the selected button can be shown on the television monitor coupled to the set top box 100 by overlaying such information on the video signal provided to the monitor over interface 106.

If desired, during operation of the set top box, the functions associated with the buttons 120 can be altered via programming executed by the host system. A change in functions can be identified to the user by changing the words or symbols shown on display 124 adjacent the effected buttons.

The host system 110 preferably includes an audio controller (i.e., an audio driver) to drive one or more speakers connected to ports 112. As noted above, volume control 130 preferably permits a user to adjust the volume level of sound generated by the speakers. A graphic representation of the level of sound preferably is shown on display 124 and changed as the volume control 130 is adjusted.

The DVD 126 preferably includes a dedicated eject button 128 that causes a tray (not specifically shown) to extend out to the user. As is well known, the tray is used to hold the disk. After a disk is placed on the tray by the user, pressing the button 128 again causes the tray to retract into the DVD device 126 in accordance with customary operation of DVD/CD ROM devices.

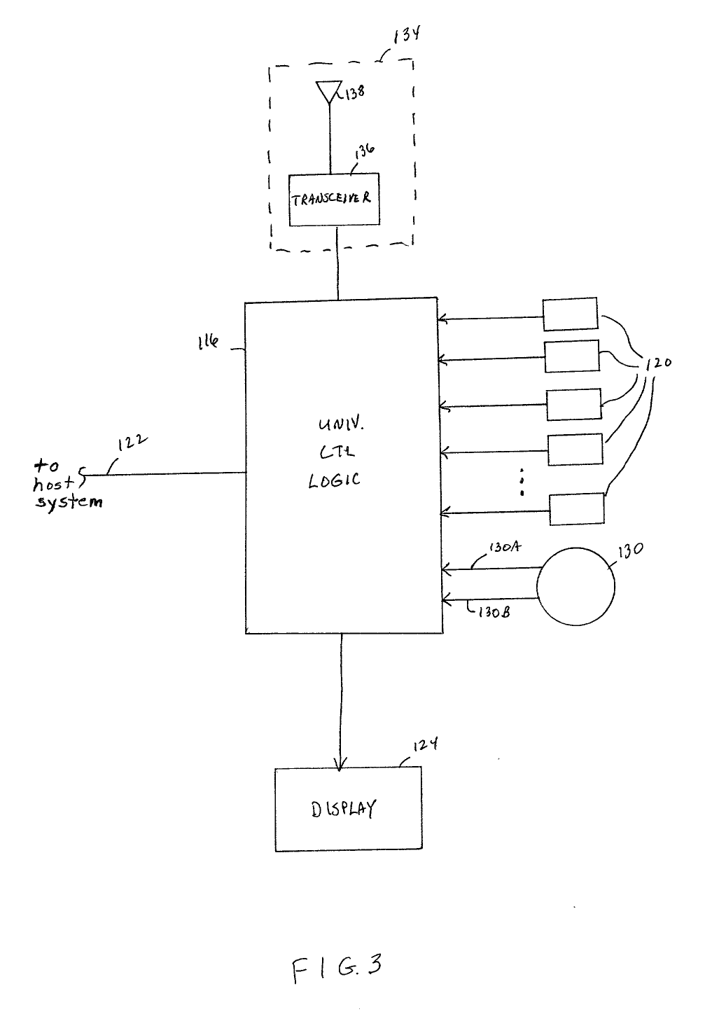

Referring now to FIGS. 1 and 3, the problem noted above regarding the need to adequately shield the electronics in the metal enclosure 102 despite numerous input/output devices (e.g., buttons 120, display 124, volume control 130) need to be coupled to the host system 110 are solved by including a universal control logic unit 116 (referred to herein as “UCL 116”). Broadly, UCL 116 interfaces the various input/devices on front bezel 118 to the host system 110 located inside the metal enclosure via preferably a single communications link 122. In accordance with a preferred embodiment of the invention discussed in greater detail below, communications link 122 comprises a standard bus connection such as a universal serial bus (“USB”), although other types of links now known or later developed can be used as well. Accordingly, UCL 116 performs one or more of the following functions:

Provides a single communication link to the host system 110 from a plurality of input/output devices;

Translates multiple disparate electrical input/output devices to a common format over the communication link;

Permits information shown on display 124 to be synchronized with comparable information shown on a television monitor coupled to the set top box 100. As shown in FIG. 3, UCL 116 bridges a plurality of input devices 120, 130, a display 124 and a communication unit 134 to single communication link 122. The communication link 122 may comprise a standard bus (e.g., USB) as noted above and, as such, may comprise a multi-conductor connection. Although link 122 may include more than one conductor, it still nevertheless comprises a single coordinated communication link.

Communication unit 134 preferably comprises a transceiver 136 coupled to an antenna 138. Antenna 138 may include a patch antenna or any other antenna suitable for RF communication. Transceiver 136 may be any suitable transceiver for driving RF energy through the antenna 138 and receiving RF signals from the antenna from external sources.

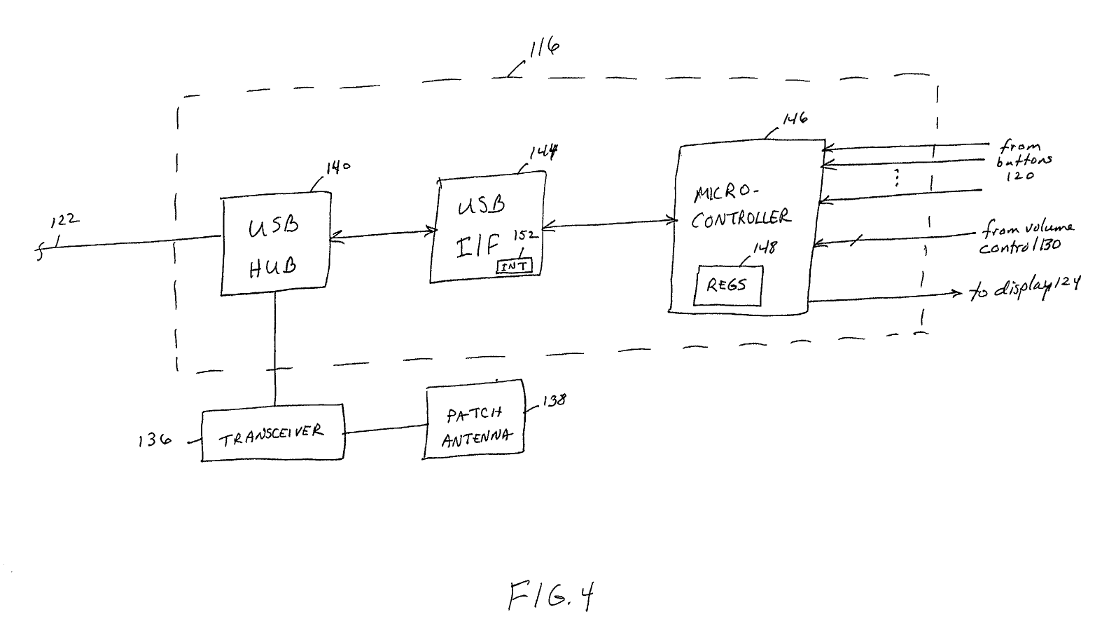

Referring now to FIG. 4, UCL 116 is shown as comprising a USB hub 140, a USB interface 144, and a microcontroller 146. USB hub 140 couples to the transceiver 136, communication link 122 and USB interface 144. USB interface 144 couples to the microcontroller 146 which also couples to the inputs 120, 130 and display 124. Microcontroller 146 can be any suitable type of microcontroller such as Intel's 8051 microcontroller. The USB interface 144 preferably is the PDIUSBD12 provided by Philips, but other suitable USB interface circuits may be acceptable as well. Among other things, the USB interface 144 includes an interrupt bit 152 which preferably is periodically checked by the host system 110 to determine whether it is set. When the interrupt bit 152 is set, the host system 110 determines that the UCL 116 requests a service of some type from the host system 110. The USB interface 144 thus can use the interrupt bit 152 to initiate communication with the host system 110. The USB hub 140 preferably is the ISP1122 provided by Philips, but can be implemented with any suitable interface device. The datasheet for the ISP 1122 is incorporated herein by reference in its entirety.

In accordance with the preferred embodiment of the inventor, host system 110 generally receives indications from the UCL 116 when the inputs 120, 130 are activated (i.e., a button 120 is pressed or volume knob 130 is turned). Host system 110 preferably coordinates the activities of the set top box 100 to perform the functions intended by the user when activating controls 120, 130. For example, if the user presses the “play” button for the DVD, host system 110 responds by causing DVD 126 to enter its play mode. Similarly, if the user turns the volume knob 130 in the direction of increased sound level, the host system 110 responds by causing the sound level to increase by a corresponding amount.

Referring still to FIG. 4, microcontroller 146 preferably facilitates communication of input control information between inputs 120, 130 and the host system 110. Preferably, microcontroller 146 includes one or more registers 148 for registering when an input control as been activated by a user. Register 148 preferably comprises a means for storing information which identifies when an input control has been activated and which control was activated. One suitable embodiment of register 148 is for the register to include at least one bit (and more if desired) associated with each input control 120, 130. As such, the “play” button has an associated bit as well as the “rewind” button, “pause” button, etc. The input signals from the controls 120, 130 preferably are provided to general purpose inputs of the microcontroller 146. The microcontroller 146 maps the general purpose inputs to corresponding bits in register 148. The bits in register 148 are referred to herein as “status flags.”

The microcontroller 146 executes code which may be stored in internal or external ROM (external ROM not shown in FIG. 4). At least one of the functions of the code is to “poll” the input signals from the input controls 120, 130. Polling means that the microcontroller periodically checks each input signal to determine which, if any, signal is asserted. Preferably, each input control signal normally is in an unasserted state (e.g., logic low) when the buttons are not pressed. When a button is pressed by a user, the input signal to the microcontroller 146 from the pressed button transitions to an asserted state (e.g., logic high). By repeatedly checking each input signal, the microcontroller will detect an asserted signal when the button associated with that input signal has been pressed. Because microcontrollers typically operate much faster than a human being is capable of pressing a button, it is virtually impossible for a human being to press and release a button before the microcontroller has an opportunity to check that signal.

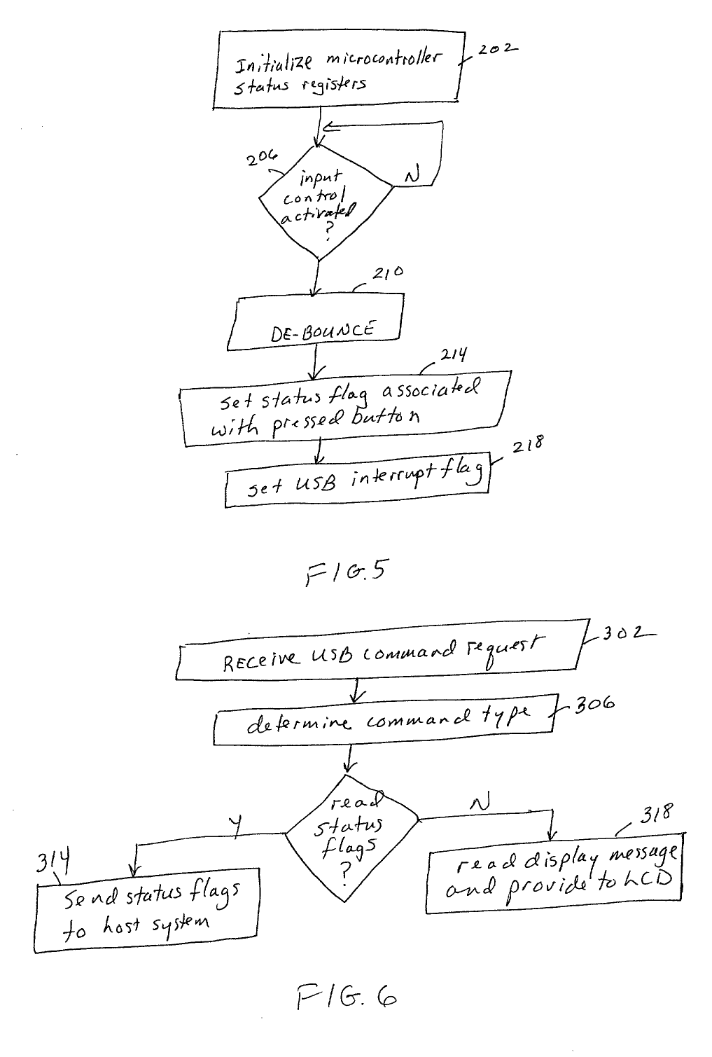

When the microcontroller determines that a particular input signal is asserted (caused by its associated input control having been activated), the microcontroller sets the bit in register 148 associated with the activated input control. FIG. 5 illustrates this in greater detail.

Referring now to FIG. 5, and in conjunction with FIG. 4, method 200 comprises an exemplary method for the UCL 116 to determine when an input control as been activated and alert the host system 110. In step 202, the microcontroller 146 at a suitable time, such as during initial power up, initializes the status registers 148. For example, the microcontroller 146 may clear all bits associated with input controls 120, 130 to a logic 0 state (or logic 1, if the opposite polarity is implemented). Then, in step 206 the microcontroller 146 cycles through each input signal to determine if the input is asserted. If no input control is asserted, the process in step 206 loops back and repeats itself. If, however, the microcontroller 146 detects that a button has been pressed, the microcontroller, through well-known code, performs a switch debouncing function in step 210. Often, when a user presses a button, the contacts in the button close and open multiple times in a transitional state between open and close, or vice versa. Debouncing a switch via hardware or software is well-known to those of ordinary skill in the art to prevent the system from reacting multiple times during this transitional episode.

In step 214, the microcontroller 146 sets the status flag in register 148 associated with the activated input control 120, 130. Finally, in step 218, the microcontroller 218 communicates with the USB interface 144 to cause the interrupt bit 152 in the interface to be set. The response of the host system 110 to a set interrupt bit 152 is illustrated in method 300 (FIG. 6).

Referring now FIG. 6, the host system 152, as noted above, periodically polls the interrupt bit 152 via the USB bus 122. When the host system 110 detects that the interrupt bit 152 is set, the host system 110 sends a USB formatted request command to the UCL 116. In step 302 in method 300, the UCL 116 receives the USB command from the host system 110. In accordance with a preferred embodiment of the invention, the host system 110 sends two general types of USB commands to the UCL 116: one type includes a request to send the states of the status flags in registers 148 to the host system 110 and the other type is to display information on the display 124 (FIG. 3) coupled to the set top box 100. These two types of messages are differentiated by different command identifiers, such as operational codes (“opcodes”), embedded in accordance with well-known techniques in the messages themselves. In step 306, the microcontroller 146 in the UCL 116 examines the USB message's opcode to determine the message type.

Decision step 310 determines whether the opcode is a request for the UCL 116 to send the status flags or for the UCL 116 to display information on the display 124. If the USB message is of the former type, step 314 is performed whereby the microcontroller 146 sends a USB message back to the host system 110 that includes all of the status flags. The host system 110 can then examine the status flags to determine which is set, determine which function (e.g., play, pause, etc.) is associated with that flag and perform the requested function. Alternatively, the UCL 116 may send only an indication of which button has been pressed and not all of the status flags. In general, the UCL 116 provides any suitable type of information to the host system 110 for the host system to ascertain what input control 120, 130 has been activated.

The other type of command message the host system 110 can provide to the UCL 116—display information on display 124—is determined in decision step 310. Preferably, the information to be displayed is included in the message itself from the host system 110 (e.g. ASCII or other suitable type of format). If the message type is, in fact, a display command, then in step 318 the UCL 116 extracts the information to be displayed from the message and displays it on the display 124. The information to be displayed may include graphics information, text information, information as to location on the display 124 for the displayed information, etc.

Referring briefly to FIG. 3, in accordance with the preferred embodiment of the invention, volume control 130 preferably includes a pair of signals 130A and 130B to the UCL 116 (and preferably the microcontroller 146 shown in FIG. 4). In accordance with the preferred embodiment, the volume control 130 comprises any suitable type of digital volume control such as that described in U.S. Pat. No. 5,963,652, incorporated herein by reference. As described in U.S. Pat. No. 5,963,652, volume control 130 includes a shaft encoder which monitors rotation of the volume knob. Through signals 130A and 130B, the volume control 130 informs the UCL 116 which direction the knob is being rotated (i.e., clockwise or counter-clockwise) by a user as the user attempts to increase or decrease the volume level. When the volume control 130 is stationary, the signals 130A and 130B are held at a constant level (e.g., logic 0). The control 130 includes a plurality of indents or clicks throughout its rotation. When the control 130 is turned, each discrete incremental click produces one pulse on each of the signals 130A and 130B. The two pulses are out of phase with respect to each other. The phase difference encodes the direction of rotation of the volume control 130. Preferably, the UCL 116 detects the phase difference and causes an appropriate response in the sound level to occur.

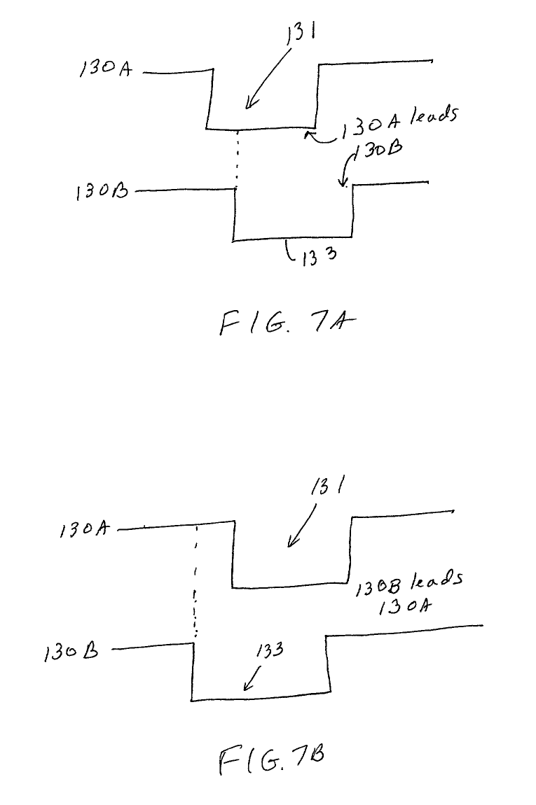

FIGS. 7A and 7B shown one exemplary embodiment of how signals 130A and 130B can be encoded to indicate direction of rotation of volume control 130. For example, as shown in FIG. 7A, if the user turns the volume knob clockwise, the pulse on signal 130A may lead the pulse on signal 130B. The UCL 116 detects that the pulse on signal 130A leads the pulse on signal 130B and determines that the user wishes to increase the volume level by one increment. One or more of the status flags in register 148 can be allocated for the purpose of the UCL 116 to communicate a new desired volume setting to the host system 110. In the manner described above, the host system 110 reads the status flag register 148 to determine the new desired volume setting and increases the volume level to the speakers (not specifically shown) appropriately. If, however, the user turns the volume control 130 counter-clockwise (volume decrease), the pulse on signal 130B leads the pulse on signal 130A (FIG. 7B) indicating the user's desired to decrease the volume level. This information is communicated to the host system 110 as described above and the volume to the speakers is decreased accordingly.

In addition to changing the volume level, the UCL 116 preferably also displays a suitable graphic depicting the volume level on display 124 to provide a visual indication to the user of that the system has responded or is responding to the user's request. Any suitable type of graphic is acceptable. One such suitable graphic includes a bar graph (horizontally or vertically oriented). The length of the bar indicates absolute or relative volume level. Thus, as the user turns the volume control clockwise to increase the volume level at the speakers, the bar graph on the display 124 also increases in length to provide a visual feedback to the user. The opposite is true when the user turns the volume control 130 counter-clockwise-the bar decreases in length.

In accordance with the preferred embodiment, the graphic feedback to the user is provided by the host system 110. In the manner described above regarding providing text information to be shown on display 124, the host system 110 preferably provides graphical information regarding the volume bar to the UCL 116 via the USB bus 122.

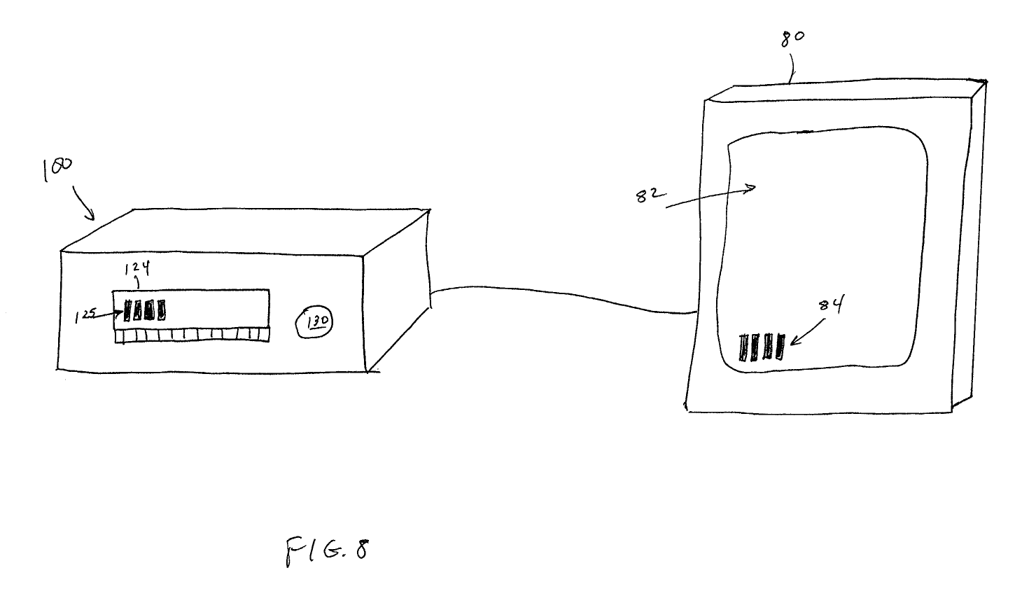

In addition to displaying volume information on display 124, set top box 100 preferably provides volume graphical information (e.g., a bar graph) over the television connection 106 (FIG. 1) to the television monitor (not shown). Such graphical information preferably is provided by superimposing the graphical information on the video signal to the television monitor in accordance with known techniques. As such, when the user turns the volume control 130 on the set top box, three things happen: (1) the sound level changes, (2) a visual feedback is provided to the user on the set top box display 124, and (3) visual feedback also is provided to the user on the television monitor. Thus, the user will, not only hear the volume change, but also see the bar graphs on both the set top box 100 and television monitor change in unison. This is illustrated in FIG. 8 in which the set top box 100 responds to a user adjusting volume control 130 by displaying a “4 bar” volume line 125 on set top box display 124 and, at substantially the same time, a 4 bar line 84 on the screen 82 of a television monitor 80. Of course, the number of bars in each volume line 125 and 84 need not be identical. In fact, the size and shape of the lines can be whatever is desired. Preferably, however, a change in volume level is shown in some suitable format on both display 124 and monitor 80 at substantially the same time. “Substantially the same time” means simply that both visual representations of volume 125 and 84 are shown soon enough after the user turns volume control 130 to provide suitable feedback information to the user. It should be understood that other types of information can be originated by the set top box 100 and displayed on the television monitor as well, such as various DVD functions (e.g., play, pause, fast forward, etc.).

As shown herein, UCL 116 is suitable to interface input controls having disparate electrical properties to a host system via a single communications link 122. For example, volume control 130 has a different electrical interface than buttons 120. In general, one or more of the controls 120, 130 may have different electrical interfaces for which UCL 116 has to account. UCL 116, in effect, has to translate these varying electrical interfaces to a common format to communicate the control information over the single communication link.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A set top box, comprising:
a host system;
a universal control logic coupled to said host system via a bus;
a plurality of input controls coupled to said universal control logic; and
a display coupled to said universal control logic;
wherein said host system is contained within a shielded enclosure and said universal control logic, said input controls and said display are located outside said shielded enclosure.

2. The set top box of claim 1 wherein said input controls include a digital volume knob.

3. The set top box of claim 1 wherein said universal control logic comprises a hub, a bus interface and a microcontroller, said bus interface coupled to said hub and said microcontroller.

4. The set top box of claim 3 wherein said bus comprises a universal serial bus.

5. The set top box of claim 3 further including a communication unit coupled to said universal control logic which sends and receives information between the set top box and other devices.

6. The set top box of claim 5 wherein said communication unit comprises an antenna and a transceiver, and wherein said transceiver is coupled to said antenna and said universal control logic.

7. The set top box of claim 3 wherein said microcontroller includes a status flag bit associated with each input control, and said microcontroller sets a status flag when the associated input control is activated.

8. The set top box of claim 7 wherein said universal control logic includes an interrupt bit that is polled by said host system over said bus.

9. An electronics devices, comprising:
a host system;
a universal control logic coupled to said host system via a bus;
a plurality of input controls coupled to said universal control logic; and
a display coupled to said universal control logic;
wherein said universal control logic formats requests over said bus to said host system to indicate a user activation of an input control and wherein said host system performs an operation associated with the user activated input control; and
wherein said host system transmits data over said bus to said universal control logic and said universal control logic provides said data to said display to be shown to a user.

10. The electronics devices of claim 9 wherein said host system is contained within a shielded enclosure and said universal control logic is not contained within said enclosure.

11. The electronics device of claim 9 wherein said universal control logic includes a storage for a plurality of status flags, each flag corresponding to one of said input controls, and said universal control logic sets a status flag when a user activates an input control corresponding to said status flag.

12. The electronics device of claim 11 wherein said universal control logic includes an interrupt request bit that said universal control logic sets when needing service from said host system.

13. The electronics device of claim 9 wherein said host system sends commands to said universal control logic over said bus and said commands include a command identifier, and said universal control logic reads the command identifier to determine the type of command.

14. The electronics device of claim 13 wherein said command identifier comprises a command selected from the group consisting of a request for the universal control logic to indicate the status of said input controls and a command for the universal control logic to show information on said display.

15. The electronics device of claim 9 wherein said input controls include a volume control providing digital inputs to said universal control logic.

16. The electronics device of claim 15 wherein said host system includes interfaces to a speaker and a television monitor, and wherein said host system responds to an activation of the volume control by changing the volume level provided to said speaker.

17. The electronics devices of claim 16 wherein said host system provides volume level information to said universal control logic which uses said volume level information to show indication of said volume level on said display.

18. The electronics device of claim 17 wherein said universal control logic shows a graphical representation of said volume level on said display.

19. The electronics device of claim 17 wherein said host system also provides a signal to said television monitor, said signal being indicative of a graphical representation of said volume level to said interface.

20. The electronics device of claim 18 wherein said host system also provides a signal to said television monitor, said signal being indicative of a graphical representation of said volume level to said interface.
